(19) United States
(12) Patent Application Publication
(10) Pub. No.: US 2026/0098476 A1
(43) Pub. Date: Apr. 9, 2026

(54) TURBINE BLADE WITH COOLING FEATURES

(71) Applicant: Solar Turbines Incorporated, San Diego, CA (US)

(72) Inventors: Aaron J. Dick, Alpharetta, GA (US); Yong W. Kim, San Diego, CA (US); David Mehaffey, San Diego, CA (US); Hasan Nasir, Escondido, CA (US); Spencer Hogan, San Diego, CA (US); Mostafa Soliman, Farmington, CT (US)

(73) Assignee: Solar Turbines Incorporated, San Diego, CA (US)

(21) Appl. No.: 18/911,067

(22) Filed: Oct. 9, 2024

(51) Int. Cl. F01D 5/18

(52) U.S. Cl. CPC F01D 5/18; F05D 2260/20

(57) ABSTRACT

During operation of a gas turbine engine, the airfoils of turbine blades are exposed to very high temperatures. Embodiments of a turbine blade may comprise an outer cooling channel, which supplies coolant to the leading edge and tip of the airfoil, and wraps around inner cooling channel(s), which supply coolant to the middle of the airfoil. These outer and inner cooling channels may merge in a merge channel with an aft cooling channel that supplies coolant to the trailing edge and tip of the airfoil. In an embodiment, discrete pressure-side and suction-side inner cooling channels may provide a flow path for coolant in opposing directions to thereby reduce temperature gradients within the airfoil. Embodiments may also comprise other cooling features, including cooling holes, trip strips, and/or pins.

### TECHNICAL FIELD

The embodiments described herein are generally directed to a turbine blade, and, more particularly, to a turbine blade with cooling features, such as wrapped multiwall serpentine internal cooling channels and/or a counter-flow cooling scheme.

### BACKGROUND

Turbine blades within gas turbine engines operate in very high-temperature and high-stress environments. For example, in some gas turbine engines, turbine blades in the first stage may be subjected to gas temperatures as high as 1500 degrees Celsius (C), which exceeds the melting temperature of the metal airfoils. Thus, it is necessary to cool each airfoil by passing coolant (e.g., cooled air or other gas extracted from the compressor) through internal passages formed inside the airfoil. The flow of coolant through the airfoils reduces the metal temperatures of the airfoils to levels that are suitable for the material's capability and stress state.

However, the gas used for the coolant reduces engine performance. Therefore, it is desirable to cool the airfoils with as little coolant as possible, to thereby minimize the impact on engine performance.

A turbine blade may utilize a multiwall-core design for cooling. A multiwall core is divided into discrete pressure-side and suction-side channels by a central spar. Such a design significantly reduces the amount of coolant required and improves cooling efficiency. In particular, the central spar is usually very cold, relative to the exterior walls of the airfoil, since the central spar is insulated from the hot gas in the external environment that is in contact with the exterior walls. The relatively cool central spar increases the surface area for heat transfer, which helps cool the airfoil with much less coolant.

However, there is a high temperature gradient between the hotter exterior walls of the airfoil and the significantly cooler central spar. A temperature gradient in any direction within the airfoil (e.g., radial, axial, or lateral) creates stress. Thus, the high temperature gradient creates high thermal stress and presents durability concerns for the multiwall-core design.

The state of the art comprises numerous designs for internal cooling passages within an airfoil. For example, U.S. Patent Pub. No. 2023/250725 A1 discloses an airfoil with a cooling passage that comprises a first section and a tip flag section. Similarly, U.S. Pat. No. 10,174,622 B2 discloses two wrapped, serpentine-shaped internal cooling paths. The present disclosure is directed toward overcoming one or more of the problems, in these and other approaches, discovered by the inventors.

### SUMMARY

In an embodiment, a turbine blade comprises: a platform; an airfoil extending radially outward from the platform; a root extending radially inward from the platform; an outer cooling channel within an interior of the turbine blade, wherein the outer cooling channel includes an outer first portion, an outer second portion, and an outer third portion, wherein the outer first portion extends radially along a leading edge of the airfoil from the platform towards a tip of the airfoil, wherein the outer second portion extends axially between a radially outer end of the outer first portion and a radially outer end of the outer third portion, and herein the outer third portion extends radially inward from an aft end of the outer second portion; one or more inner cooling channels within the interior of the turbine blade, wherein each of the one or more inner cooling channels includes an inner first portion, an inner second portion, and an inner third portion, wherein the inner first portion is aft of the outer first portion and extends radially from the platform to a position that is radially inward from the outer second portion, wherein the inner second portion extends axially between a radially outer end of the inner first portion and a radially outer end of the inner third portion, and wherein the inner third portion is forward of the outer third portion and extends radially inward from an aft end of the inner second portion; and one or more cooling holes extending from the aft end of the outer second portion of the outer cooling channel towards the tip of the turbine blade.

In an embodiment, a turbine blade comprises: a platform; an airfoil extending radially outward from the platform; a root extending radially inward from the platform; an outer cooling channel within an interior of the turbine blade, wherein the outer cooling channel includes an outer first portion, an outer second portion, and an outer third portion, wherein the outer first portion extends radially along a leading edge of the airfoil from the platform towards a tip of the airfoil, wherein the outer second portion extends axially between a radially outer end of the outer first portion and a radially outer end of the outer third portion, and wherein the outer third portion extends radially inward from an aft end of the outer second portion; one or more inner cooling channels within the interior of the turbine blade, wherein each of the one or more inner cooling channels includes an inner first portion, an inner second portion, and an inner third portion, wherein the inner first portion is aft of the outer first portion and extends radially from the platform to a position that is radially inward from the outer second portion, wherein the inner second portion extends axially between a radially outer end of the inner first portion and a radially outer end of the inner third portion, and wherein the inner third portion is forward of the outer third portion and extends radially inward from an aft end of the inner second portion; and a merge channel, wherein the outer third portion of the outer cooling channel and the inner third portion of each of the one or more inner cooling channels is in fluid communication with the merge channel.

In an embodiment, a turbine blade comprises: a platform; an airfoil extending radially outward from the platform; a root extending radially inward from the platform; a first inner cooling channel within an interior of the turbine blade on a first lateral side of the turbine blade; and a second inner cooling channel within the interior of the turbine blade on a second lateral side of the turbine blade that is opposite the first lateral side, wherein each of the first and second inner cooling channels includes a first portion, a second portion, and a third portion, wherein the first portion extends radially from the platform towards a tip of the airfoil, wherein the second portion extends axially between a radially outer end of the first portion and a radially outer end of the third portion, and wherein the third portion extends radially inward from an aft end of the second portion, wherein the first portion of the first inner cooling channel is in fluid communication with a first inlet that supplies coolant to the first portion of the first inner cooling channel, such that, when the coolant is supplied to the first inlet, the coolant flows in a first direction from the first inlet to the first portion of the first inner cooling channel, to the second portion of the first inner cooling channel, and to the third portion of the first inner cooling channel, and wherein the third portion of the second inner cooling channel is in fluid communication with a second inlet that supplies coolant to the third portion of the second inner cooling channel, such that, when the coolant is supplied to the second inlet, the coolant flows in a second direction, which is reverse of the first direction, from the second inlet to the third portion of the second inner cooling channel, to the second portion of the second inner cooling channel, and to the first portion of the second inner cooling channel.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a schematic diagram of a gas turbine engine, according to an embodiment;

FIG. 2 is a partially assembled turbine rotor assembly, according to an embodiment;

FIG. 3 is a perspective view of a turbine blade, according to an embodiment;

FIGS. 4A and 4B are transparent views of a turbine blade, from a pressure side and suction side, respectively, according to an embodiment;

FIG. 5 is a transparent, pressure-side view of a turbine blade, illustrating flow paths, according to an embodiment;

FIG. 6 is a cross-sectional view of a turbine blade, in which the cross-sectional plane is orthogonal to a radial axis, according to an embodiment;

FIGS. 7A-7D are transparent, pressure-side views of a turbine blade, illustrating the position of a central spar, according to alternative embodiments;

FIG. 8 is a transparent, pressure-side view of a turbine blade, illustrating various turning vanes, according to an embodiment;

FIG. 9 is a transparent, pressure-side view of a turbine blade, illustrating various dimensions, according to an embodiment;

FIGS. 10A and 10B are transparent views of a turbine blade, from a pressure side and suction side, respectively, according to an embodiment;

FIGS. 11A and 11B are perspective views of inner cooling channels, in isolation, from a pressure side and a suction side, respectively, according to an embodiment; and

FIG. 12 is a cross-sectional view of a turbine blade, in which the cross-sectional plane is orthogonal to a radial axis, illustrating the flow paths of coolant within inner cooling channels, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

References herein to “upstream” and “downstream” or “forward” and “aft” are relative to the flow direction of the primary gas (e.g., air, fuel, combustor discharge gas, etc.) being discussed, unless specified otherwise. It should be understood that “upstream,” “forward,” and “leading” refer to a position that is closer to the source of the primary gas or a direction towards the source of the primary gas, and “downstream,” “aft,” and “trailing” refer to a position that is farther from the source of the primary gas or a direction that is away from the source of the primary gas. Thus, a trailing edge or end of a component (e.g., a turbine blade) is downstream from a leading edge or end of the same component. Also, it should be understood that, as used herein, the terms “side,” “top,” “bottom,” “front,” “rear,” “above,” “below,” and the like are used for convenience of understanding to convey the relative positions of various components with respect to each other, and do not imply any specific orientation of those components in absolute terms (e.g., with respect to the external environment or the ground). In addition, the terms “respective” and “respectively” signify an association between members of a group of first components and members of a group of second components. For example, the phrase “each component A connected to a respective component B” would signify A1 connected to B1, A2 connected to B2, . . . and AN connected to BN. Furthermore, as used herein, a reference numeral with an appended letter will be used to refer to a specific component, whereas the same reference numeral without any appended letter will be used to refer collectively to a plurality of the component or to refer to a generic or arbitrary instance of the component.

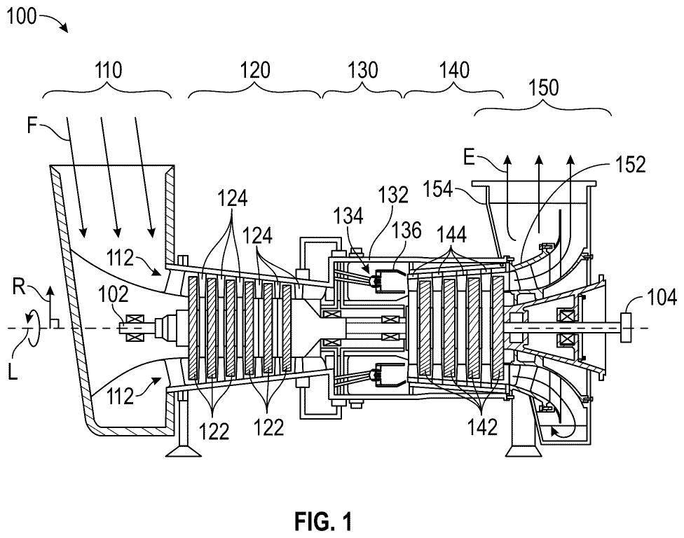

FIG. 1 illustrates a schematic diagram of a gas turbine engine 100, according to an embodiment. Gas turbine engine 100 comprises a shaft 102 with a central longitudinal axis L. A number of other components of gas turbine engine 100 are concentric with longitudinal axis L and may be annular around longitudinal axis L. A radial axis may refer to any axis or direction that radiates outward from longitudinal axis L at a substantially orthogonal angle to longitudinal axis L, such as radial axis R in FIG. 1. Thus, the term “radially outward” should be understood to mean farther from or away from longitudinal axis L, whereas the term “radially inward” should be understood to mean closer to or towards longitudinal axis L. As used herein, the term “radial” will refer to any axis or direction that is substantially perpendicular to longitudinal axis L, and the term “axial” will refer to any axis or direction that is substantially parallel to longitudinal axis L.

In an embodiment, gas turbine engine 100 comprises, from an upstream end to a downstream end, an inlet 110, a compressor 120, a combustor 130, a turbine 140, and an exhaust outlet 150. In addition, the downstream end of gas turbine engine 100 may comprise a power output coupling 104. One or more, including potentially all, of these components of gas turbine engine 100 may be made from stainless steel and/or durable, high-temperature materials known as “superalloys.” A superalloy is an alloy that exhibits excellent mechanical strength and creep resistance at high temperatures, good surface stability, and corrosion and oxidation resistance. Examples of superalloys include, without limitation, Hastelloy, Inconel, Waspaloy, Rene alloys, Haynes alloys, Incoloy, MP98T, TMS alloys, and single-crystal nickel-based alloys (e.g., CSMX™).

Inlet 110 may funnel a working fluid F into an annular flow path 112 around longitudinal axis L. Working fluid F flows through inlet 110 into compressor 120. While working fluid F is illustrated as flowing into inlet 110 from a particular direction and at an angle that is substantially orthogonal to longitudinal axis L, it should be understood that inlet 110 may be configured to receive working fluid F from any direction and at any angle that is appropriate for the particular application of gas turbine engine 100. While working fluid F will primarily be described herein as air, it should be understood that working fluid F could comprise other fluids, including other gases.

Compressor 120 may comprise a series of compressor rotor assemblies 122 and compressor stator assemblies 124. Each compressor rotor assembly 122 may comprise a rotor disk that is circumferentially populated with a plurality of rotor blades. The rotor blades in a rotor disk are separated, along the axial axis, from the rotor blades in an adjacent disk by a compressor stator assembly 124. Compressor 120 compresses working fluid F through a series of stages corresponding to each compressor rotor assembly 122. The compressed working fluid F then flows from compressor 120 into combustor 130.

Combustor 130 may comprise a combustor case 132 that houses one or more, and generally a plurality of, fuel injectors 134. In an embodiment with a plurality of fuel injectors 134, fuel injectors 134 may be arranged circumferentially around longitudinal axis L within combustor case 132 at equidistant intervals. Combustor case 132 diffuses working fluid F, and fuel injector(s) 134 inject fuel into working fluid F. This injected fuel is ignited to produce a combustion reaction in one or more combustion chambers 136. The product of the combustion reaction drives turbine 140.

Turbine 140 may comprise one or more turbine rotor assemblies 142 and turbine stator assemblies 144 (e.g., nozzles). Each turbine rotor assembly 142 may correspond to one of a plurality or series of stages. Turbine 140 extracts energy from the combusting fuel-gas mixture as it passes through each stage. The energy extracted by turbine 140 may be transferred via power output coupling 104 (e.g., to an external system), as well as to compressor 120 via shaft 102. Shaft 102 may be a single shaft, or may be divided into two sections with the forward section connected to and driving compressor 120 and the aft section connected to outlet coupling 104 for energy transfer.

The exhaust E from turbine 140 may flow into exhaust outlet 150. Exhaust outlet 150 may comprise an exhaust diffuser 152, which diffuses exhaust E, and an exhaust collector 154 which collects, redirects, and outputs exhaust E. It should be understood that exhaust E, output by exhaust collector 154, may be further processed, for example, to reduce harmful emissions, recover heat, and/or the like. In addition, while exhaust E is illustrated as flowing out of exhaust outlet 150 in a specific direction and at an angle that is substantially orthogonal to longitudinal axis L, it should be understood that exhaust outlet 150 may be configured to output exhaust E towards any direction and at any angle that is appropriate for the particular application of gas turbine engine 100.

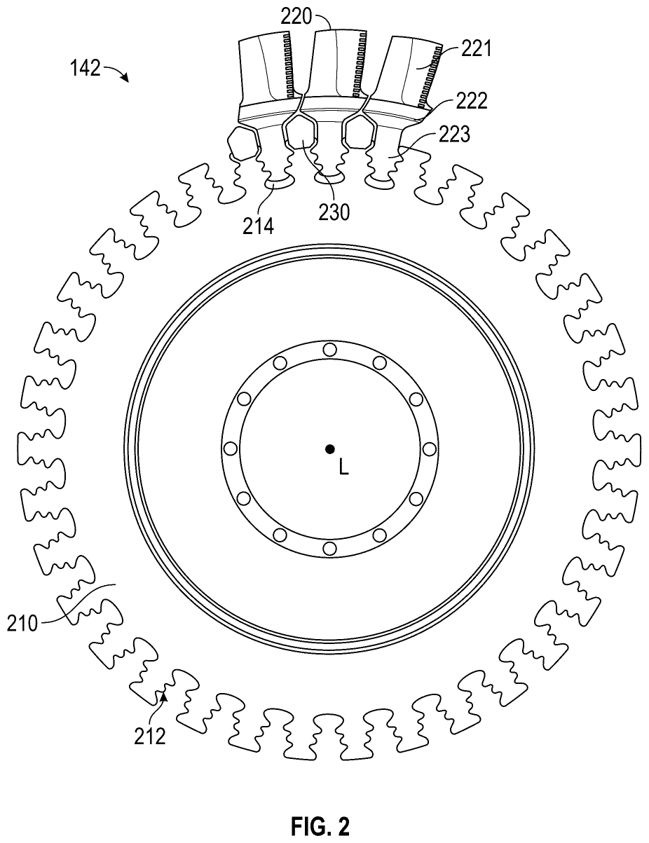

FIG. 2 is a partially assembled turbine rotor assembly 142 of gas turbine engine 100, according to an embodiment. Each turbine rotor assembly 142 may comprise a rotor disk 210 that is annular around and concentric with longitudinal axis L. Rotor disk 210 may comprise a plurality of axial attachment grooves 212 arranged at equidistant intervals around the circumference of rotor disk 210. While rotor disk 210 is illustrated with thirty-four attachment grooves 212, it should be understood that rotor disk 210 may comprise any number of attachment grooves 212, depending on applicable design factors.

Each attachment groove 212 is configured to receive a turbine blade 220 therein. Each turbine blade 220 may comprise an airfoil 221, platform 222, and root 223. The sides of root 223 of each turbine blade 220 are configured to mate with the sides of at least one attachment groove 212, such that root 223 may be slid axially into a respective attachment groove 212. The cross-sectional profiles of attachment groove 212 and root 223 may have a “fir tree,” “bulb,” “dove tail,” or other shape to prevent radial movement of root 223 relative to attachment groove 212. Thus, the engagement of root 223 with attachment groove 212 radially fixes turbine blade 220 within attachment groove 212. It should be understood that other components, when assembled into gas turbine engine 100, may act as retaining features to prevent axial movement of turbine blades 220.

When fully assembled, each attachment groove 212 in rotor disk 210 may hold a respective turbine blade 220. Thus, turbine rotor assembly 142 may comprise a plurality of turbine blades 220 arranged annularly around longitudinal axis L, with the platform 222 of each turbine blade 220 abutting the platform 222 of adjacent turbine blades 220 on both long sides, and each airfoil 221 extending from platform 222 along a radial axis R. Turbine rotor assembly 142, comprising a plurality of turbine blades 220, may be positioned in any one or more stages of turbine 140. In an embodiment, turbine blades 220 are comprised in a turbine rotor assembly 142 in at least the first stage of turbine 140, which is generally exposed to the highest gas temperatures and mechanical stresses. However, it should be understood that turbine blades 220 may be comprised in any subset of turbine rotor assemblies 142, including potentially all of turbine rotor assemblies 142 in turbine 140.

Root 223 of each turbine blade 220 may radially penetrate only partially into attachment groove 212, such that a cavity 214 is formed within each attachment groove 212, between the radially innermost end of root 223 and the radially innermost end of attachment groove 212. An under-platform cavity may also be formed under (i.e., radially inward from) platforms 222, between roots 223 of each pair of adjacent turbine blades 220 and/or radially outward from rotor disk 210.

A damper 230 may be fixed in the under-platform cavity between each pair of adjacent turbine blades 220. Each damper 230 may be configured to constrain or seal coolant within the under-platform cavity, such that positive pressure is created in the under-platform cavity, to thereby suppress the ingress of hot gases from above (i.e., radially outward from) platforms 222. This sealing and positive pressure also enables under-platform cavity to retain coolant (e.g., air that has been bled from compressor 120), whereby coolant to turbine blade 220 can be supplied from cavity 214. In an alternative embodiment in which adjacent platforms 222 are sufficiently flush with an outer circumference of rotor disk 210, the under-platform cavity is sufficiently small, or an alternative sealing feature is used, dampers 230 may be omitted. For example, in a contemplated alternative embodiment, a pin seal is used between adjacent turbine blades 220 to prevent hot gases from entering the cavity between adjacent turbine blades 220.

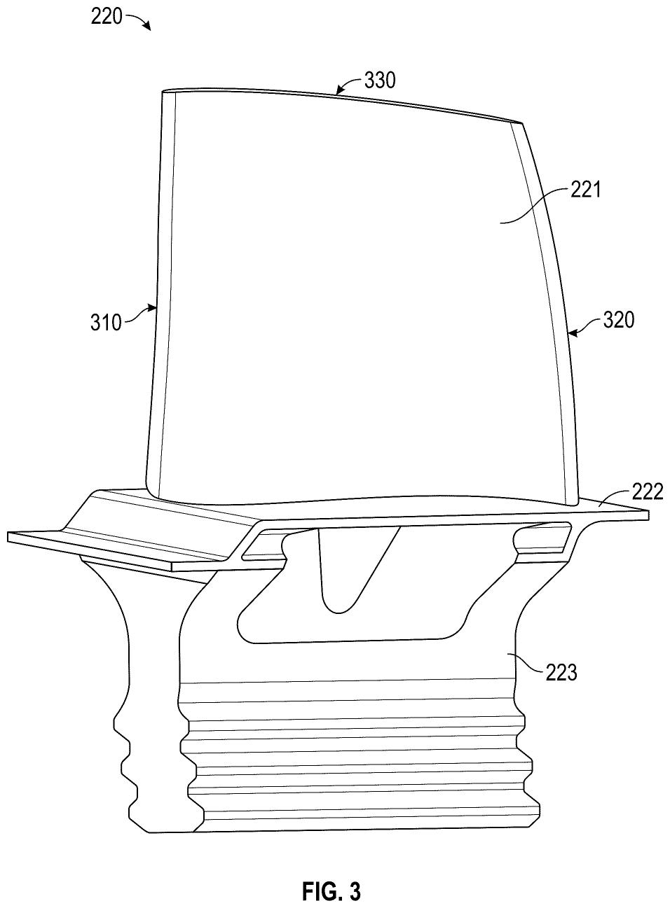

FIG. 3 is a perspective view of turbine blade 220, according to an embodiment. As illustrated, airfoil 221 of each turbine blade 220 comprises a leading edge 310 on the forward end of airfoil 221, a trailing edge 320 on the aft end of airfoil 221, and a tip 330 at a radially outermost end of airfoil 221. Airfoil 221 extends radially outward from platform 222, and root 223 extends radially inward from platform 222.

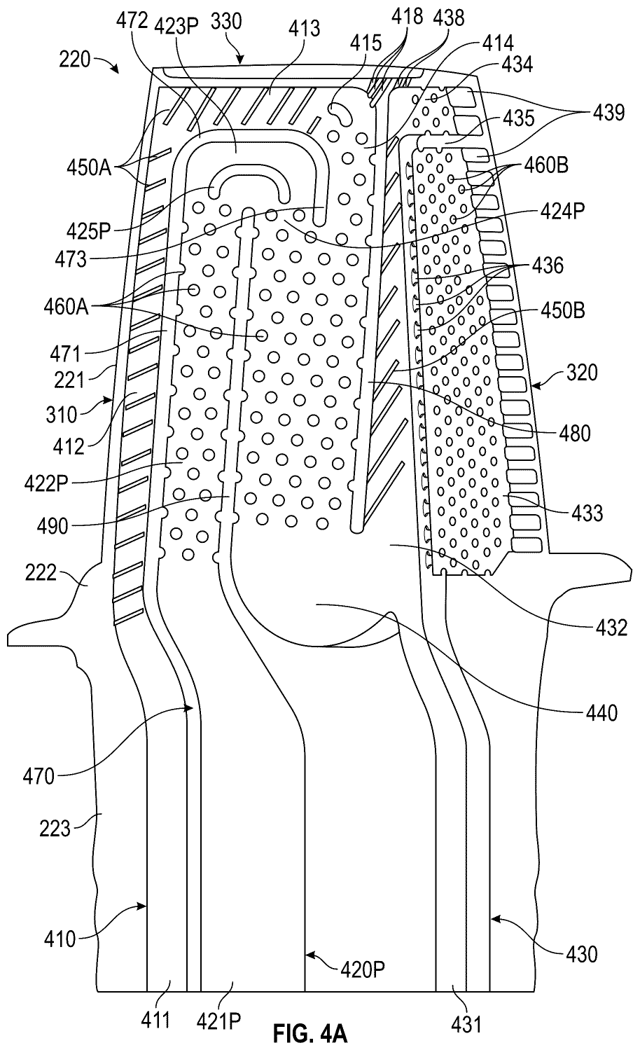

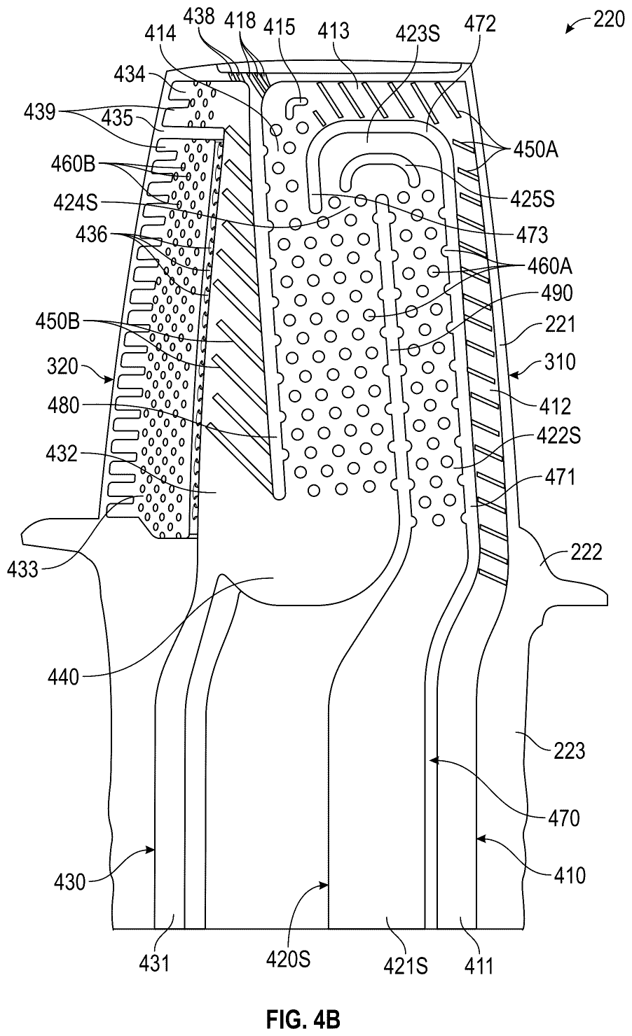

FIG. 4A is a transparent, pressure-side view of turbine blade 220, and FIG. 4B is a transparent, suction-side view of turbine blade 220, according to an embodiment. In these views, the exterior walls of turbine blade 220 are shown as transparent, such that the interior cooling features of turbine blade 220 are visible. These interior cooling features may comprise an outer cooling channel 410, at least one inner cooling channel 420, an aft cooling channel 430, and a merge channel 440. It should be understood that each cooling channel 410, 420, 430, and 440 represents negative space within turbine blade 220, through which coolant (e.g., air or other gas extracted from compressor 120) may flow.

Outer cooling channel 410, within the interior of turbine blade 220, may comprise an outer inlet 411, an outer first portion 412, an outer second portion 413, and an outer third portion 414. Outer inlet 411 may extend through an outer surface (e.g., radially inward-most surface) of root 223, such that outer inlet 411 is in fluid communication with a source of coolant (e.g., cavity 214), so as to supply coolant to outer cooling channel 410. Each of outer inlet 411, outer first portion 412, outer second portion 413, and outer third portion 414 may be in fluid communication with each other. In particular, outer first portion 412, which may be directly connected to outer inlet 411, may extend radially along leading edge 310 of airfoil 221 from platform 222 towards tip 330 of airfoil 221. Outer second portion 413 may extend axially between a radially outer end of outer first portion 412 and a radially outer end of outer third portion 414. Outer third portion 414 may extend radially inward from an aft end of outer second portion 413 towards platform 222. Thus, coolant may flow into outer inlet 411 (e.g., from cavity 214), then from outer inlet 411 through outer first portion 412, from outer first portion 412 through outer second portion 413, and from outer second portion 413 through outer third portion 414, to thereby cool the regions of airfoil 221 around outer cooling channel 410.

In an embodiment, turbine blade 220 comprises two inner cooling channels 420, with a first inner cooling channel 420P on the pressure side of turbine blade 220, which may also be referred to herein as pressure-side inner cooling channel 420P, and a second inner cooling channel 420S on the suction side of turbine blade 220, which may also be referred to herein as suction-side inner cooling channel 420S. Conceptually, the two inner cooling channels 420P and 420S may be a single inner cooling channel 420 that is divided in two by a central spar, as discussed elsewhere herein. In an alternative embodiment, turbine blade 220 consists of only a single contiguous inner cooling channel 420. More generally, one or more inner cooling channels 420 may be provided within the interior of turbine blade 220.

Each inner cooling channel 420 (e.g., pressure-side inner cooling channel 420P and suction-side inner cooling channel 420S) may comprise an inner inlet 421, an inner first portion 422, an inner second portion 423, and an inner third portion 424. For example, pressure-side inner cooling channel 420P comprises pressure-side inner inlet 421P, pressure-side inner first portion 422P, pressure-side inner second portion 423P, and pressure-side inner third portion 424P, and suction-side inner cooling channel 420S comprises suction-side inlet 421S, suction-side inner first portion 422S, suction-side inner second portion 423S, and suction-side inner third portion 424S. In an embodiment, pressure-side inner inlet 421P and suction-side inner inlet 421S may be one in the same. In this case, inner inlet 421 may split, into pressure-side inner cooling channel 420P and suction-side inner cooling channel 420S, at a position in root 223, platform 222, or airfoil 221. Alternatively, pressure-side inner inlet 421P could be separate and discrete from suction-side inner inlet 421S. Each inner inlet 421 may extend through an outer surface (e.g., radially inward-most surface) of root 223, such that inner inlet 421 is in fluid communication with a source of coolant (e.g., cavity 214), so as to supply coolant to the respective inner cooling channel 420.

Each of inner inlet 421, inner first portion 422, inner second portion 423, and inner third portion 424 may be in fluid communication with each other. In particular, a radially inner end of inner first portion 422 of at least one inner cooling channel 420 may be in direct or indirect fluid communication with inner inlet 421, which supplies coolant to inner first portion 422. Inner first portion 422 may extend radially from platform 222 to a position that is radially inward from outer second portion 413. Inner second portion 423 may extend axially between a radially outer end of inner first portion 422 and a radially outer end of inner third portion 424. Inner third portion 424, which may be forward of outer third portion 414, may extend radially inward from an aft end of inner second portion 423 towards platform 222. Thus, coolant may flow into inner inlet 421 (e.g., from cavity 214), then from inner inlet 421 through inner first portion 422, from inner first portion 422 through inner second portion 423, and from inner second portion 423 through inner third portion 424, to thereby cool the regions of airfoil 221 around inner cooling channel 420.

Aft cooling channel 430, within the interior of turbine blade 220, may be aft of inner cooling channel(s) 420. Aft cooling channel 430 may comprise an aft inlet 431, an aft first portion 432, an aft second portion 433, and an aft third portion 434. Aft inlet 431 may extend through an outer surface (e.g., radially inward-most surface) of root 223, such that aft inlet 431 is in fluid communication with a source of coolant (e.g., cavity 214), so as to supply coolant to aft cooling channel 430. Each of aft inlet 431, aft first portion 432, aft second portion 433, and aft third portion 434 may be in fluid communication with each other. In particular, aft first portion 432, which may be directly connected to aft inlet 431, may extend radially from aft inlet 431 towards tip 330 of airfoil 221. Aft second portion 433 may extend axially from aft first portion 432 towards trailing edge 320 of airfoil 221. Aft third portion 434 may extend axially from a radially outer end of aft first portion 432 towards trailing edge 320 of airfoil 221. Aft third portion 434 may be positioned radially outward from aft second portion 433 and separated from aft second portion 433 by a rib 435. Each of aft second portion 433 and aft third portion 434 may comprise one or more outlets 439 at trailing edge 320 of airfoil 221, from which coolant is discharged into the flow path of working fluid F. Thus, coolant may flow into aft inlet 431 (e.g., from cavity 214), then from aft inlet 431 through aft first portion 432, from aft first portion 432 through aft second portion 433 and out trailing edge 320 via one or more outlets 439, and from aft first portion 432 through aft third portion 434 and out trailing edge 320 via one or more outlets 439, to thereby cool the regions of airfoil 221 around aft cooling channel 430, including the surfaces along trailing edge 320 of airfoil 221. Notably aft inlet 431 may be separate from inner inlet 421. Alternatively, aft inlet 431 may one in the same with inner inlet 421, and the shared inlet may separate into inner cooling channel(s) 420 and aft channel 430 at a position in airfoil 221, platform 222, or root 223.

In an embodiment, aft first portion 432 is in fluid communication with aft second portion 433 via a plurality of discrete cross-overs 436 designed to meter and radially distribute coolant flowing from aft first portion 432 to aft second portion 433. In contrast, the radially outward end of aft first portion 432 may transition into aft third portion 434 without any discrete cross-overs. The lack of discrete cross-overs between aft first portion 432 and aft third portion 434 enables as much coolant as possible to flow from aft first portion 432 to aft third portion 434, to thereby provide as much cooling as possible to trailing edge 320 at or near tip 330.

Merge channel 440 provides fluid communication between outer cooling channel 410 and inner cooling channel 420 and aft cooling channel 430. In particular, outer third portion 414 of outer cooling channel 410 and inner third portion 424 of each inner cooling channel 420 may be in fluid communication with merge channel 440, which may be in fluid communication with aft cooling channel 430. For example, the radially inner end of outer third portion 414 may merge into each inner third portion 424, and merge channel 440 may extend from a radially inner end of the merged third portions 414/424 into aft channel 430 at a position in aft channel 430 that is in platform 222, in airfoil 221 near platform 222, and/or in root 223 near platform 222. In the event that there are two inner cooling channels 420P and 420S, it should be understood that both inner third portion 424P of the first or pressure-side inner cooling channel 420P and inner third portion 424S of the second or suction-side inner cooling channel 420S may be connected to merge channel 440.

In an embodiment, one or more of the cooling channels, within the interior of turbine blade 220, may comprise one or more cooling holes through an exterior surface of turbine blade 220, to thereby expel coolant from turbine blade 220. These cooling hole(s) may extend through an exterior surface of turbine blade 220 at or near tip 330 of airfoil 221, so as to eject coolant out of airfoil 221 at or near tip 230 of airfoil 221, to thereby cool these regions.

For example, outer cooling channel 410 may comprise one or more cooling holes 418 extending from the aft end of outer second portion 413 of outer cooling channel 410 towards tip 330 of turbine blade 220. This first set of cooling hole(s) 418 may extend through an exterior surface of airfoil 221 at or near tip 330, so as to eject coolant out of airfoil 221 near tip 330 of airfoil 221. Cooling hole(s) 418 may extend through a pressure-side surface of airfoil 221 near tip 330, through a suction-side surface of airfoil 221 near tip 330, through the radially outward facing surface of tip 330, through a transitional region between the pressure-side surface and/or suction-side surface of airfoil 221 and the radially outward facing surface of tip 330, and/or the like. While a few cooling holes 418 are illustrated, it should be understood that outer cooling channel 410 may comprise any number of cooling holes 418, including one, two, three, four, five, or more cooling holes 418, positioned according to any suitable arrangement for cooling tip 330 at an axial position between outer cooling channel 410 and aft cooling channel 430.

As another example, aft cooling channel 430 may comprise one or more cooling holes 438 extending from the radially outer end of aft first portion 432 of aft cooling channel 430 towards tip 330 of turbine blade 220. This second set of cooling hole(s) 438 may extend through an exterior surface of airfoil 221 at or near tip 330, so as to eject coolant out of airfoil 221 near tip 330 of airfoil 221. Cooling hole(s) 438 may extend through a pressure-side surface of airfoil 221 near tip 330, through a suction-side surface of airfoil 221 near tip 330, through the radially outward facing surface of tip 330, through a transitional region between the pressure-side surface and/or suction-side surface of airfoil 221 and the radially outward facing surface of tip 330, and/or the like. While a couple cooling holes 438 are illustrated, it should be understood that aft cooling channel 430 may comprise any number of cooling holes 438, including one, two, three, four, five, or more cooling holes 438, positioned according to any suitable arrangement for cooling tip 330 at an axial position between outer cooling channel 410 and aft cooling channel 430.

In an embodiment, one or more cooling channels, within the interior of turbine blade 220, may comprise one or more turning vanes designed to improve heat exchange, provide structural integrity to airfoil 221, and/or improve the flow of coolant through the cooling channels. In the illustrated embodiment, turbine blade 220 comprises a turning vane 415 extending laterally, between the pressure side and the suction side of airfoil 221, through a transitional region between outer second portion 413 and outer third portion 414 of outer cooling channel 410. Alternatively or additionally, turbine blade 220 could comprise a turning vane extending laterally, between the pressure side and the suction side of airfoil 221, through a transitional region between outer first portion 412 and outer second portion 413 of outer cooling channel 410.

In addition, inner second portion 423 of each inner cooling channel 420 may comprise a turning vane 425. Turning vane 425 is illustrated as turning vane 425P in pressure-side inner cooling channel 420P and turning vane 425S in suction-side inner cooling channel 420S. In practice, it should be understood that turning vanes 425P and 425S may be one in the same. In particular, turning vane 425 may extend laterally, between the pressure side and the suction side of airfoil 221, through inner second portion 423 of each of pressure-side inner cooling channel 420P and suction-side inner cooling channel 420S.

In an embodiment, one or more of the cooling channels, within the interior of turbine blade 220, may comprise one or more trip strips 450 designed to turbulate the flow of coolant through the respective cooling channel. For example, outer cooling channel 410 may comprise a plurality of trip strips 450A, and aft cooling channel 430 may comprise a plurality of trip strips 450B. Trips strips 450 may be provided on the pressure side and/or suction side of the respective cooling channel. In the illustrated embodiment, each of outer first portion 412 and outer second portion 413 of outer cooling channel 410 comprises a plurality of trip strips 450A on both the pressure side and the suction side. In addition, aft first portion 432 of aft cooling channel 430 comprises a plurality of trip strips 450 on both the pressure side and the suction side. It should be understood that trip strips 450 may be provided on other surfaces of the various cooling channels than those specifically illustrated and discussed herein, including on surfaces of one or more cooling channels that extend between the pressure side and suction side.

In each case, trip strips 450 may be spaced apart along the respective portion of the respective cooling channel, uniformly or non-uniformly, according to any suitable distance interval or intervals. The particular spacing may depend on the particular design goals. Each trip strip 450 may be oriented at an angle with respect to a radial axis and axial axis, and trip strips 450 may all be oriented in the same direction or two or more trip strips 450 may be oriented in different directions. While trip strips 450 are illustrated in a particular arrangement, it should be understood that trip strips 450 may be alternatively implemented in any other suitable arrangement.

In an embodiment in which trip strips 450 are provided on both the pressure side and suction side of a cooling channel, trip strips 450 may be staggered across the respective cooling channel, such that each trip strip 450 on the pressure side does not laterally align with any trip strip 450 on the suction side. This means that the flow of coolant will hit a trip strip 450 on a first side, then hit a trip strip 450 on a second side, then hit a trip strip 450 on the first side, then hit a trip strip 450 on the second side, and so on and so forth. Alternatively, trip strips 450 on the pressure side of a cooling channel may be mirrored or otherwise aligned to trip strips 450 on the suction side of the same cooling channel, such that the flow of coolant simultaneously hits an aligned pair of trip strips 450 on the pressure and suction sides of the cooling channel. In either case, there may be an equal number of trip strips 450 on the pressure side as on the suction side of a given cooling channel, or a different number of trip strips 450 on the pressure side than on the suction side of the given cooling channel. However, it is generally beneficial for trip strips 450 to be arranged in a uniform manner along the respective cooling channel.

In an embodiment, one or more of the cooling channels, within the interior of turbine blade 220, may comprise one or more pins 460 designed to improve heat exchange and/or provide structural integrity to airfoil 221. For example, at least portions of outer cooling channel 410, inner cooling channel(s) 420, and aft cooling channel 430 may comprise a plurality of pins 460 extending laterally between the pressure side and the suction side of airfoil 221. Each pin 460 may laterally span the entirety or a portion (e.g., half) of the respective cooling channel between the pressure and suction sides of the respective cooling channel. In the illustrated embodiment, outer third portion 414 of outer cooling channel 410 comprises a plurality of pins 460A, outer first portion 422 and outer third portion 424 of each inner cooling channel 420 comprise a plurality of pins 460B, and aft second portion 433 and aft third portion 434 of aft cooling channel 430 comprise a plurality of pins 460C. Notably, the region in which outer third portion 414 and inner third portion 424 merge within merge channel 440, may also comprise a plurality of pins 460.

Pins 460 may be arranged throughout the respective cooling channel, either uniformly or non-uniformly, according to any suitable pattern. While pins 460 are illustrated as being present in only certain regions of certain cooling channels, pins 460 may be formed in any region of any cooling channel within turbine blade 220, including in airfoil 221, platform 222, and/or root 223. For example, pins 460 could extend further radially down than shown, into the radially innermost portion of merge region 440. In addition, while pins 460 are illustrated as having a circular profile in side view, pins 460 may have any suitable shape, including an oblong or other elliptical profile, a square profile, a tear-drop profile, or the like. Furthermore, one or more pins 460 may have different shapes and/or dimensions than other pins 460. In an alternative embodiment, pins 460 may be omitted altogether and/or replaced with alternative features (e.g., trip strips) that perform similar or different functions.

In an embodiment, turbine blade 220 may comprise one or more ribs that separate two or more cooling channels or two or more portions of the same cooling channel. In the illustrated embodiment, turbine blade 220 comprises a first rib 470, a second rib 480, and a third rib 490. First rib 470 separates outer cooling channel 410 from inner cooling channel(s) 420. First rib 470 may include a first rib portion 471 that separates outer first portion 412 of outer cooling channel 410 from inner first portion 422 of each inner cooling channel 420, a second rib portion 472 that separates outer second portion 413 of outer cooling channel 410 from inner second portion 423 of each inner cooling channel 420, and a third rib portion 473 that separates outer third portion 414 of outer cooling channel 410 from inner third portion 424 of each inner cooling channel 420 for a least a portion of their spans. In other words, first rib 470 wraps around inner cooling channel(s) 420. Second rib 480 may extend radially to separate outer cooling channel 410 and each inner cooling channel 420 from aft cooling channel 430. As illustrated, the radially innermost end of third rib portion 473 may be farther (i.e., more radially outward) from platform 222 than the radially innermost end of second rib 480. Third rib 490 may extend radially to separate inner first portion 422 of each inner cooling channel 420 from inner third portion 424 of each inner cooling channel 420.

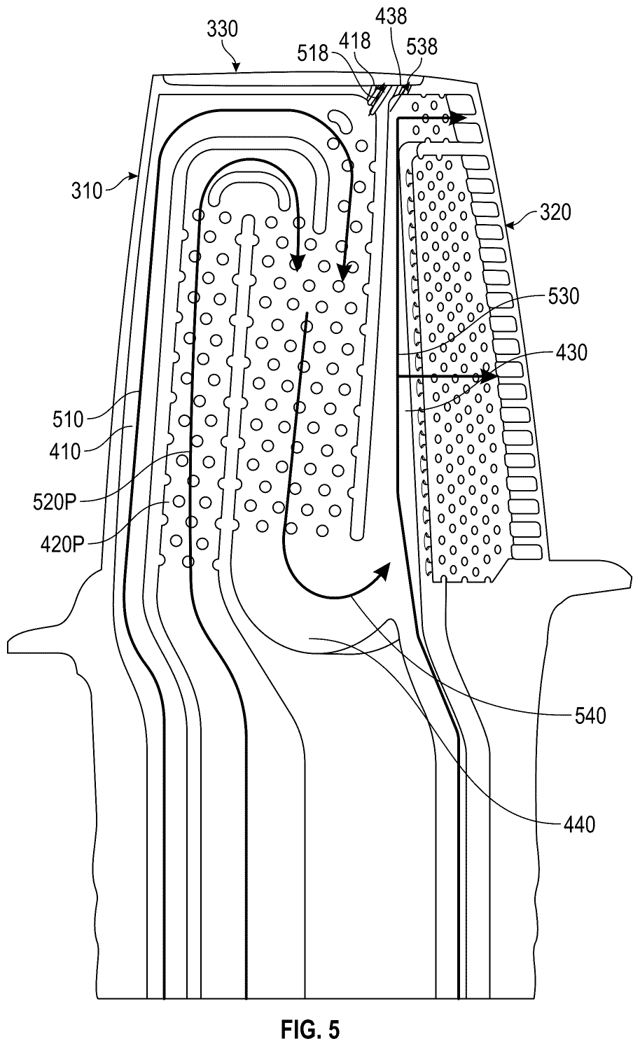

FIG. 5 is a transparent, pressure-side view of turbine blade 220, illustrating flow paths, according to an embodiment. It should be understood that these flow paths are coolant flow paths, in which the flow directions of the coolant are defined by the positions of their respective inlets and outlets. As illustrated, outer cooling channel 410 may form an outer flow path 510 through which coolant may flow radially outward along leading edge 310, thereby cooling leading edge 310, axially downstream along tip 330, thereby cooling tip 330, and radially inward into merge channel 440, thereby cooling a middle region of airfoil 221. In addition, cooling holes 418 may provide a first tip-cooling flow path 518 to the external environment around tip 330, to thereby cool tip 330 in a region above second rib 480. Each inner cooling channel 420 may form an inner flow path 520 (e.g., pressure-side inner flow path 520P, and a corresponding suction-side inner flow path which is not visible) through which coolant may flow radially outward, axially downstream, and radially inward into merge channel 440 to join outer flow path 510, thereby cooling a middle region of airfoil 221. Aft cooling channel 430 may form an aft flow path 530 through which coolant may flow radially outward and axially downstream out of outlets 439 through trailing edge 320, thereby cooling the aft region and trailing edge 320 of airfoil 221. In addition, cooling holes 438 may provide a second tip-cooling flow path 538 to the external environment around tip 330, to thereby cool tip 330 in a region above second rib 480. Merge channel 440 may form an intermediate flow path 540 through which coolant may flow from outer cooling channel 410 and inner cooling channel(s) 420 to aft cooling channel 430, thereby cooling a middle region of airfoil 221.

In an embodiment, at least a portion of each of outer cooling channel 410 and/or merge channel 440 may also be split into parallel channels. For example, outer cooling channel 410 could be split into a pressure-side outer cooling channel and a suction-side outer cooling channel along at least a portion of outer second portion 413 and/or outer third portion 414, such that flow path 510 is bifurcated into pressure-side and suction-side flow paths. The pressure-side outer cooling channel of outer cooling channel 410 may merge with pressure-side inner cooling channel 420P and the suction-side outer cooling channel of outer cooling channel 410 may merge with suction-side inner cooling channel 420S, at the radially outermost portion of merge channel 440, such that the radially outermost portion of merge channel 440 is also split and flow path 540 is also bifurcated into pressure-side and suction-side flow paths. Within merge channel 440, the merged pressure-side cooling channel may merge with the merged suction-side cooling channel, to thereby merge the pressure-side and suction-side flow paths of flow path 540 into a single flow path, within which the pressure-side and suction-side coolant can mix.

Notably, aft cooling channel 431 may be supplied with coolant by both merge channel 440 and aft inlet 431. The coolant being supplied through aft inlet 431 will be cooler than the warmed coolant being supplied by merge channel 440. Thus, aft inlet 431 acts as a bypass that cools the coolant in flow path 530 of aft cooling channel 430.

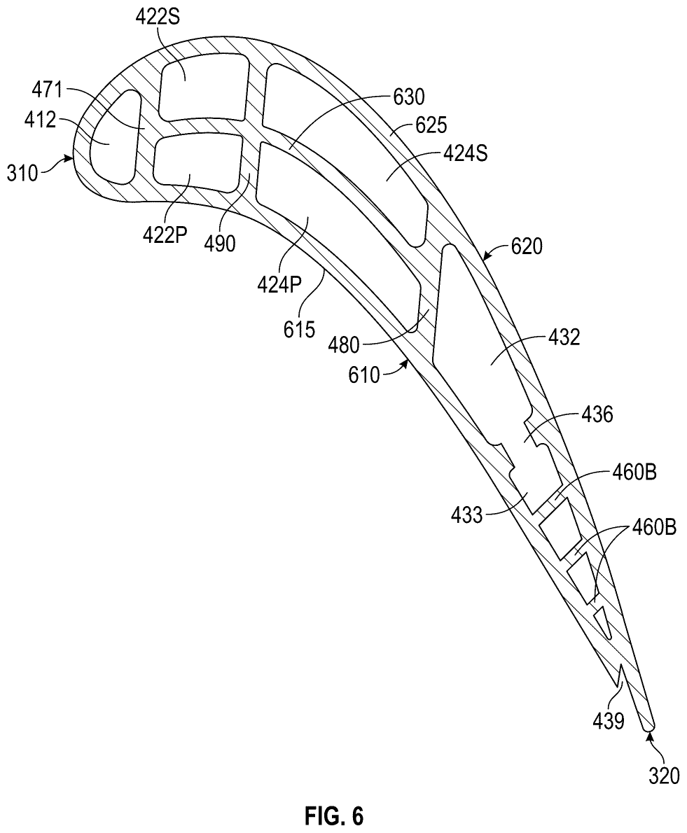

FIG. 6 is a cross-sectional view of turbine blade 220, in which the cross-sectional plane is orthogonal to a radial axis, according to an embodiment. In the illustrated embodiment, inner cooling channels 420 consist of two inner cooling channels 420, including pressure-side inner cooling channel 420P, positioned on pressure side 610 of turbine blade 220, and suction-side inner cooling channel 420S, positioned on suction side 620 of turbine blade 220. In this cross-section, regions of outer first portion 412 of outer cooling channel 410, inner first portion 422P of pressure-side inner cooling channel 420P, inner first portion 422S of suction-side inner cooling channel 420S, inner third portion 424P of pressure-side inner cooling channel 420P, inner third portion 424S of suction-side inner cooling channel 420S, and aft first portion 432 and aft second portion 433 of aft cooling channel 430 are visible, including pins 460B and an outlet 439.

At least a portion of pressure-side inner cooling channel 420P, which may also be referred to herein as the first inner cooling channel, is separated from at least a portion of suction-side inner cooling channel 420S, which may also be referred to herein as the second inner cooling channel, by a central spar 630 between a pressure-side wall 615 and a suction-side wall 625 of airfoil 221. In other words, turbine blade 220 comprises a first inner cooling channel 420 within an interior of turbine blade 220 on a first lateral side of turbine blade 220, and a second inner cooling channel 420 within the interior of turbine blade 220 on a second lateral side of turbine blade 220 that is opposite the first lateral side, with central spar 620 therebetween. During operation of gas turbine engine 100, a temperature gradient will exist between pressure-side wall 615 and central spar 630 and between suction-side wall 625 and central spar 630, due to the high temperatures to which the exterior surfaces of pressure-side wall 615 and suction-side wall 625 are exposed and the cooler temperatures to which central spar 630 is exposed.

Notably, the dimensions of pressure-side inner cooling channel 420P and suction-side inner cooling channel 420S may differ due to the shape of airfoil 221. Accordingly, it should be understood that pressure-side inner cooling channel 420P and suction-side inner cooling channel 420S are not necessarily identical in shape and, in practice, will typically have different shapes.

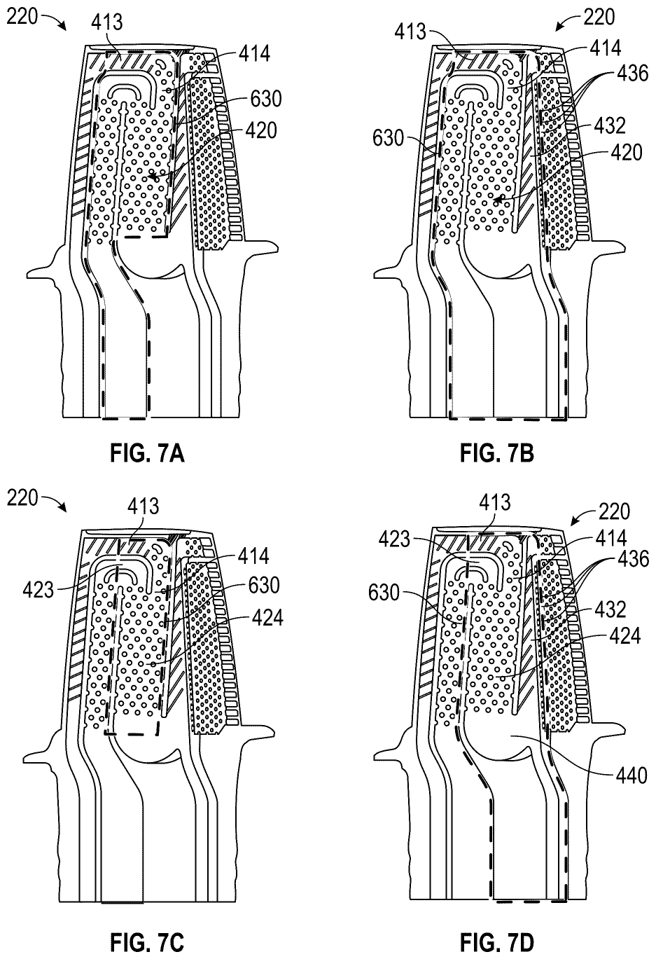

FIG. 7A is a transparent, pressure-side view of turbine blade 220, illustrating the position of central spar 630, according to a first embodiment. The position of central spar 630 is indicated by a dashed outline. In this first embodiment, central spar 630 separates the entireties of the two inner cooling channels 420 from each other. In particular, central spar 630 separates the entireties of inner first portion 422P, inner second portion 423P, and inner third portion 424P of pressure-side inner cooling channel 420P from the entireties of inner first portion 422S, inner second portion 423S, and inner third portion 424S, respectively, of suction-side inner cooling channel 420S. In addition, central spar 630 may further separate an aft part of outer second portion 413 and an entirety of outer third portion 414 of outer cooling channel 410 into a pressure-side channel and a suction-side channel.

FIG. 7B is a transparent, pressure-side view of turbine blade 220, illustrating the position of central spar 630, according to a second embodiment. Again, the position of central spar 630 is indicated by a dashed outline. This second embodiment is similar to the first embodiment, except that central spar 630 extends more aft-ward to divide aft first portion 432 into a pressure-side channel and a suction-side channel. In all other respects, the first and second embodiments may be identical.

FIG. 7C is a transparent, pressure-side view of turbine blade 220, illustrating the position of central spar 630, according to a third embodiment. Again, the position of central spar 630 is indicated by a dashed outline. In this third embodiment, central spar 620 separates only a portion of the two inner cooling channels 420 from each other. In particular, central spar 630 may separate an aft part of inner second portion 423P and an entirety of inner third portion 424P of pressure-side inner cooling channel 420P from an aft part of inner second portion 423S and an entirety of inner third portion 424S, respectively, of suction-side inner cooling channel 420S. In this case, inner first portion 422P of pressure-side inner cooling channel 420P and inner first portion 422S of suction-side inner cooling channel 420S may be one in the same (i.e., a single channel), and a forward part of inner second portion 423P of pressure-side inner cooling channel 420P and a forward part of inner second portion 423S of suction-side inner cooling channel 420S may be one in the same (i.e., a single channel). In addition, central spar 630 may further separate an aft part of outer second portion 413 and an entirety of outer third portion 414 of outer cooling channel 410 into a pressure-side channel and a suction-side channel.

FIG. 7D is a transparent, pressure-side view of turbine blade 220, illustrating the position of central spar 630, according to a fourth embodiment. Again, the position of central spar 630 is indicated by a dashed outline. This fourth embodiment is similar to the third embodiment, except that central spar 630 extends more aft-ward to divide aft first portion 432 into two parallel channels. In all other respects, the third and fourth embodiments may be identical.

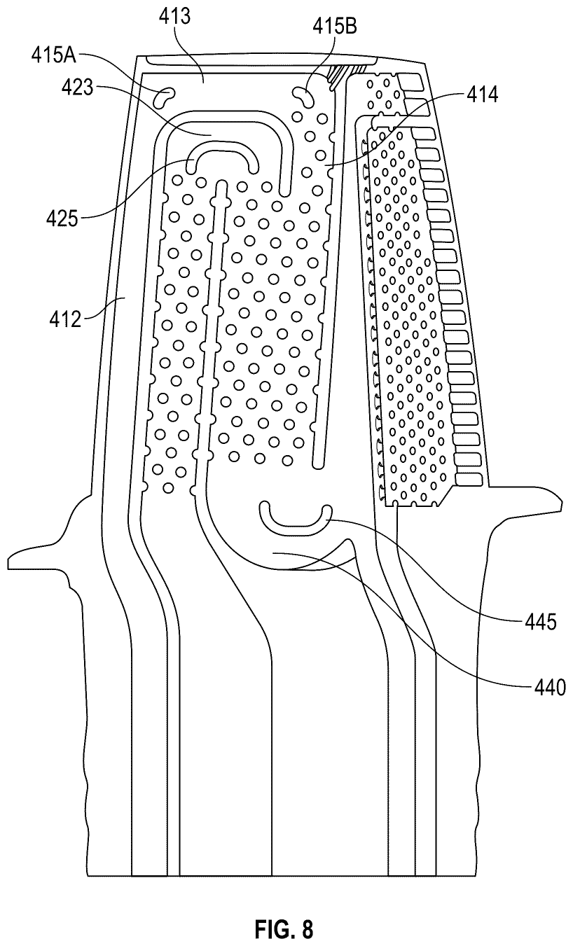

FIG. 8 is a transparent, pressure-side view of turbine blade 220, illustrating various turning vanes, according to an embodiment. Turning vanes may be used to improve heat exchange (e.g., by increasing surface area and/or decreasing flow area), provide structural integrity to airfoil 221, and/or improve the flow of coolant through the cooling channels (e.g., by guiding the flow of coolant, preventing flow separation, etc.).

In an embodiment, turbine blade 220 comprises a turning vane 415A extending laterally, between pressure side 610 and suction side 620 of airfoil 221, through a transitional region between outer first portion 412 and outer second portion 413 of outer cooling channel 410, and a turning vane 415B extending laterally, between pressure side 610 and suction side 620 of airfoil 221, through a transitional region between outer second portion 413 and outer third portion 414 of outer cooling channel 410. As illustrated, each turning vane 415 has a curved profile, in side view, that generally follows the curvature of the respective transitional region.

In an embodiment, turbine blade 220 comprises a turning vane 425 extending laterally, between pressure side 610 and suction side 620 of airfoil 221, through inner second portion 423 of each inner cooling channel 420. As illustrated, turning vane 425 has a curved, generally U-shaped or rainbow-shaped profile, in side view, that generally follows the curvature of inner second portion 423. Although only a single turning vane 425 is illustrated, turbine blade 220 may comprise a plurality of turning vanes 425.

In an embodiment, turbine blade 220 comprises a turning vane 445 extending laterally, between pressure side 610 and suction side 620 of airfoil 221, through merge channel 440. As illustrated, turning vane 445 has a curved, generally U-shaped or rainbow-shaped profile, in side view, that generally follows the curvature of merge channel 440. The radially innermost point (i.e., bottom) of turning vane 445 may be positioned in airfoil 221, platform 222 (e.g., as illustrated), or root 223, depending on applicable design factors. Although only a single turning vane 445 is illustrated, turbine blade 220 may comprise a plurality of turning vanes 445.

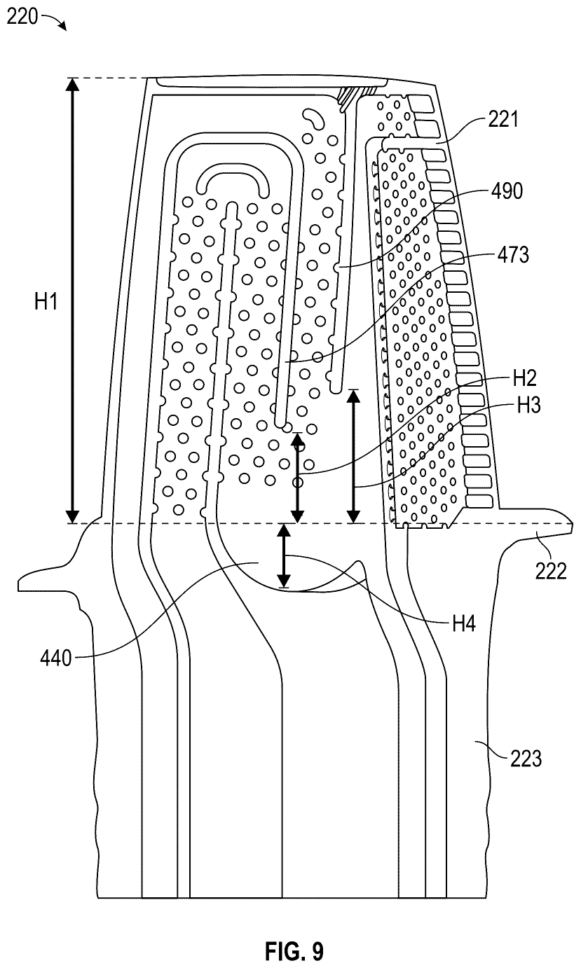

FIG. 9 is a transparent, pressure-side view of turbine blade 220, illustrating various dimensions, according to an embodiment. The illustrated dimensions include the radial height H1 of airfoil 221, the radial distance H2 between the radially outward facing surface of platform 222 and the radially innermost end of third rib portion 473 of first rib 470, the radial distance H3 between the radially outward facing surface of platform 222 and the radially innermost end of third rib 490, and the radial distance H4 between the radially outward facing surface of platform 222 and the radially innermost end of merge channel 440. In an embodiment, radial distance H2 is between 0% to 80% of radial height H1, radial distance H3 is 0% to 15% of radial height H1, and radial distance H4 is 0% to 30% of radial height H1. Notably, as radial distance H2 is decreased, third rib portion 473 extends further radially inward to divide the bank of pins 460 in outer third portion 414 and the bank of pins 460 in inner third portion 424. In other words, radial distance H2 controls the merge point for coolant flowing out of outer cooling channel(s) 410 and inner cooling channel(s) 420.

In an embodiment that comprises or consists of two inner cooling channels 420, such as pressure-side inner cooling channel 420P and suction-side inner cooling channel 420S, inner flow path 520 (e.g., pressure-side and suction-side inner flow paths 520) for both of the two inner cooling channels 420 may be in the same direction. For example, the radially inner end of inner first portion 422 of each of the two inner cooling channels 420 may be in fluid communication with the same inner inlet 421 or respective separate and discrete inner inlets 421 that supply coolant to the inner first portion 422 of each of the two inner cooling channels 420, such that, when the coolant is supplied to inner inlet(s) 421, the coolant flows in the same direction from inner inlet(s) 421 to inner first portion 422 of each of the two inner cooling channels 420, to inner second portion 423 of each of the two inner cooling channels 420, and to inner third portion 424 of each of the two inner cooling channels 420. However, in an alternative embodiment, inner flow paths 520 for the two inner cooling channels 420 may be in opposite directions.

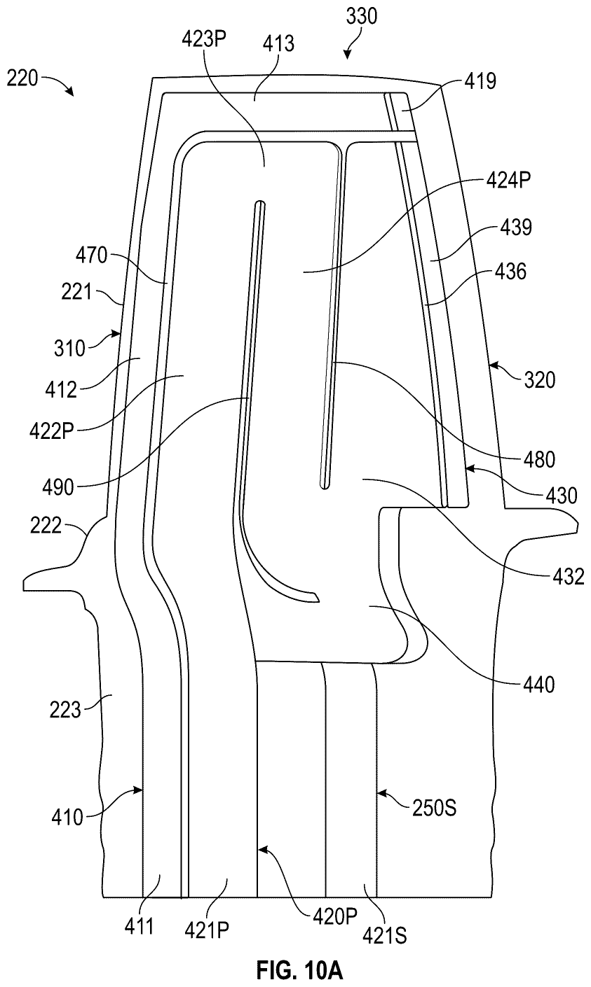

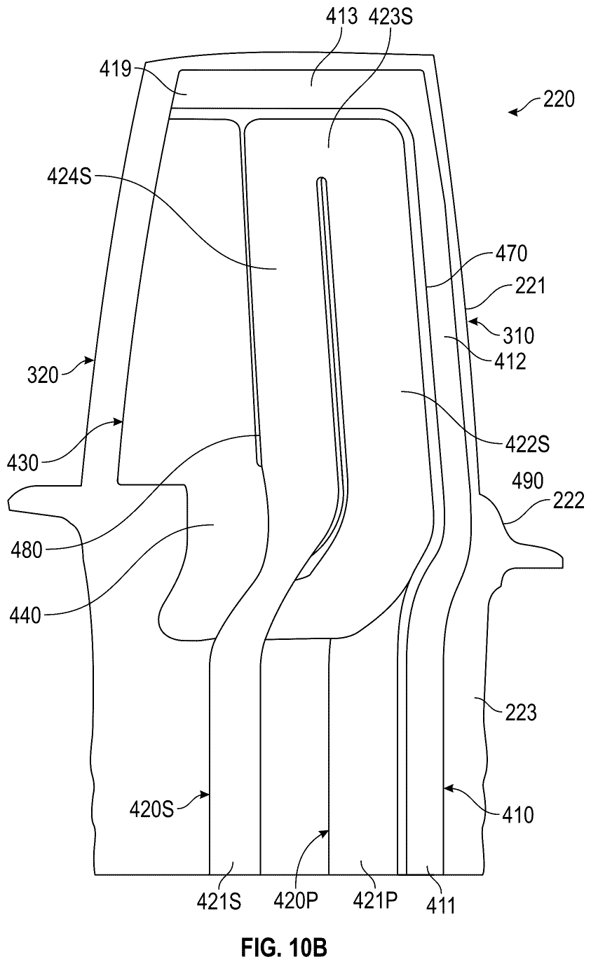

FIG. 10A is a transparent, pressure-side view of turbine blade 220, and FIG. 10B is a transparent, suction-side view of turbine blade 220, according to an embodiment in which inner flow paths 520 for the two inner cooling channels 420 are in opposite directions. In other words, in this embodiment, coolant within pressure-side inner cooling channel 420P flows in an opposite direction than coolant within suction-side inner cooling channel 420S. For example, inner first portion 422P of a first inner cooling channel 420P is in fluid communication with a first inner inlet 421P that supplies coolant to inner first portion 422P of first inner cooling channel 422P, such that, when the coolant is supplied to first inner inlet 422P, the coolant flows in a first direction from first inner inlet 421P to inner first portion 422P of first inner cooling channel 420P, to inner second portion 423P of first inner cooling channel 420P, and to inner third portion 424P of first inner cooling channel 420P, whereas inner third portion 424S of second inner cooling channel 420S is in fluid communication with a second inner inlet 421S that supplies coolant to inner third portion 424S of second inner cooling channel 420S, such that, when the coolant is supplied to second inner inlet 421S, the coolant flows in a second direction, which is reverse of the first direction, from inner second inlet 421S to inner third portion 424S of second inner cooling channel 420S, to inner second portion 423S of second inner cooling channel 420S, and to inner first portion 422S of second inner cooling channel 420S.

In this embodiment, outer cooling channel 410 is not in fluid communication with inner cooling channels 420 or aft cooling channel 430, and does not comprise an outer third portion 414. Rather, outer second portion 413 is formed as an axial tip flag that terminates in one or more outlets 419 at trailing edge 320 of airfoil 221. Thus, coolant may flow into inlet 411 (e.g., from cavity 214), then from outer inlet 411 through outer first portion 412, from outer first portion 412 through outer second portion 413 and out trailing edge 320 via one or more outlets 419, to thereby cool the regions of airfoil 221 around outer cooling channel 410, including the surfaces along trailing edge 320 of airfoil 221.

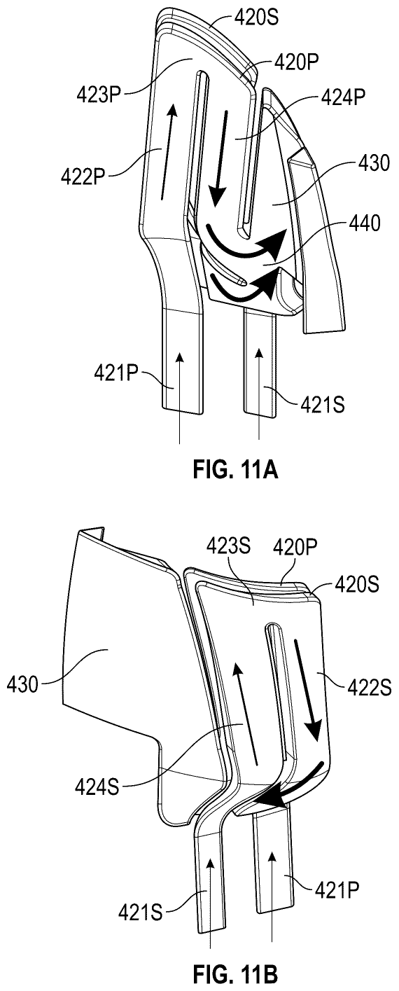

FIG. 11A is a pressure-side, perspective view of inner cooling channels 420 in isolation, and FIG. 11B is a suction-side, perspective view of inner cooling channels 420 in isolation, according to an embodiment in which inner flow paths 520 for inner cooling channels 420 are in opposite directions. It should be understood that the illustrated cooling channels 420 represent negative space within the interior of turbine blade 220. The direction of coolant flow in each inner flow path 520 is illustrated by arrows.

In this example, the coolant in pressure-side inner cooling channel 420P flows generally aft-ward, whereas the coolant in suction-side inner cooling channel 420S flows generally forward. In this case, inner inlet 421P is forward of inner inlet 421S. In pressure-side inner cooling channel 420P, coolant flows from inner inlet 421P, radially outward through inner first portion 422P, axially aft-ward through inner second portion 423P, radially inward through inner third portion 424P, and into a forward portion of merge channel 440. In suction-side inner cooling channel 420S, coolant flows from inner inlet 421S, radially outward through inner third portion 424S, axially forward through inner second portion 423S, radially inward through inner first portion 422S, and then through an aft-ward turn into an aft portion of merge channel 440. From merge channel 440, the coolant may flow into aft cooling channel 430 in the same manner as described elsewhere herein.

Notably, the thickness of the arrows represents the temperature of the coolant flowing along respective portions of inner cooling channels 420, with thinner arrows representing coolant with relatively lower temperatures and thicker arrows representing coolant with relatively higher temperatures. As shown, the coolant is coolest at inlets 421P and 421S. Due to heat exchange, the coolant warms as it flows through inner first portion 422P and inner third portion 424S, further warms as it flows through inner second portion 423P and inner second portion 423S, further warms as it flows through inner third portion 424P and inner first portion 422S, and is hottest in merge channel 440. The reversal of the flow directions, with respect to each other, matches relatively cooler coolant in pressure-side inner cooling channel 420P with relatively warmer coolant in suction-side inner cooling channel 420S, in a lateral direction, to thereby reduce the overall temperature gradients along both radial and axial axes in airfoil 221. For example, reverse temperature gradients in inner first portions 422P and 422S are paired to reduce an overall radial, axial, and lateral temperature gradient in this region of airfoil 221, reverse temperature gradients in the coolants in inner second portions 423P and 423S are paired to reduce an overall radial, axial, and lateral temperature gradient in this region of airfoil 221, and reverse temperature gradients in inner third portions 424P and 424S are paired to reduce an overall radial, axial, and lateral temperature gradient in this region of airfoil 221.

In an alternative embodiment, the flow directions may be reversed, such that the coolant in pressure-side inner cooling channel 420P flows generally forward, whereas the coolant in suction-side inner cooling channel 420S flows generally aft-ward. In this case, inner inlet 421P would be aft of inner inlet 421S. In suction-side inner cooling channel 420S, coolant would flow from inner inlet 421S, radially outward through inner first portion 422S, axially aft-ward through inner second portion 423S, radially inward through inner third portion 424S, and into a forward portion of merge channel 440. In pressure-side inner cooling channel 420P, coolant would flow from inner inlet 421P, radially outward through inner third portion 424P, axially forward through inner second portion 423P, radially inward through inner first portion 422P, and then through an aft-ward turn into an aft portion of merge channel 440. From merge channel 440, the coolant may flow into aft cooling channel 430 in the same manner as described elsewhere herein.

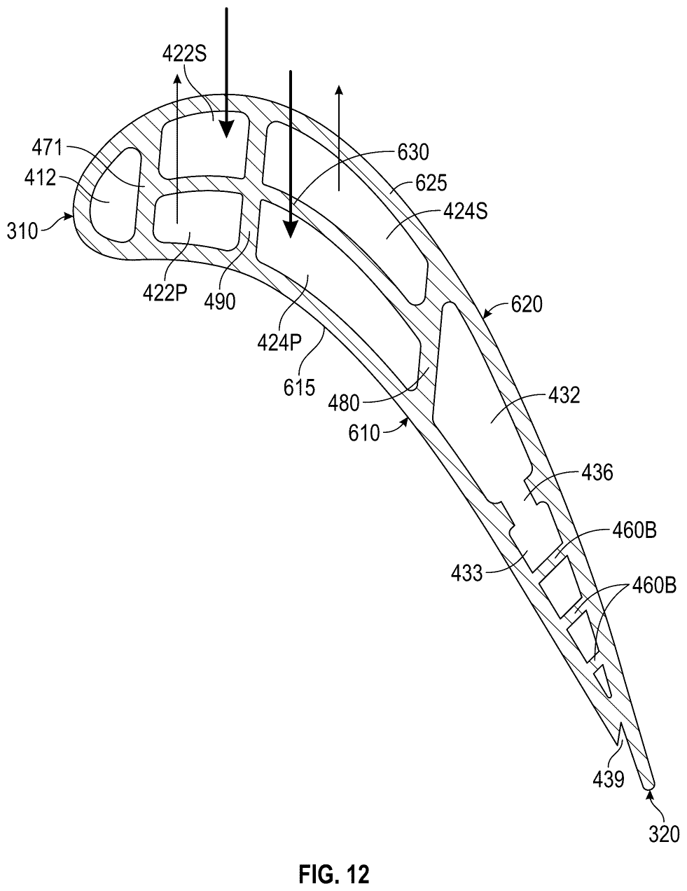

FIG. 12 is a cross-sectional view of turbine blade 220, in which the cross-sectional plane is orthogonal to a radial axis, illustrating the flow paths of coolant, including flow directions, within inner cooling channels 420, according to an embodiment. Again, the thickness of the arrows represents the temperature of the coolant flowing along respective portions of inner cooling channels 420, with thinner arrows representing coolant with relatively lower temperatures and thicker arrows representing coolant with relatively higher temperatures. Thus, it can be seen that coolant flowing through inner first portion 422P is cooler than coolant flowing through inner first portion 422S, and coolant flowing through inner third portion 424P is warmer than coolant flowing through inner third portion 424S, thereby reducing the overall radial, axial, and lateral temperature gradients in airfoil 221.

### Industrial Applicability

During operation of a gas turbine engine, the turbine blades in the turbine of the gas turbine engine are exposed to very high temperatures. To mitigate these high temperatures, turbine blades are designed with internal cooling passages. In a multiwall-core design, each turbine blade comprises discrete pressure-side and suction-side cooling passages, separated by a central spar. However, during operation, high temperature gradients form between the exterior walls of the airfoil and the central spar, which creates high thermal stress and durability concerns due to the differences in the thermal expansion of materials forming the exterior walls and central spar. Disclosed embodiments reduce these high temperature gradients along radial, axial, and/or lateral axes, thereby reducing the thermal stress on turbine blades 220 and increasing the durability of those turbine blades 220.

In an embodiment, one or more, including potentially all, turbine blades 220 in one or more, including potentially all, stages of turbine 140 comprise a “wrapped” serpentine configuration in which a forwardmost and outer cooling channel 410 extends along leading edge 310 of airfoil 221 to tip 330 of airfoil and wraps around at least one inner cooling channel 420, and preferably both a pressure-side inner cooling channel 420P and a suction-side inner cooling channel 420S. Outer cooling channel 410 may be redirected radially inward to merge with inner cooling channel(s) 420 in a merge channel 440.

Firstly, this configuration increases the cooling efficiency within airfoil 221, since the coolant used by outer cooling channel 410 to cool leading edge 310 of airfoil 221 is reused for a middle region of airfoil 221, as opposed to being ejected from trailing edge 320 of airfoil 221, as in traditional multiwall-core designs. Secondly, in embodiments that comprise pressure-side inner cooling channel 420P and suction-side inner cooling channel 420S, the configuration reduces the temperature gradients between external walls 615 and 625 of airfoil 221 and central spar 630, since the coolant from outer cooling channel 410 will be pre-warmed before it merges with the coolant in inner cooling channels 420. The reduction in temperature gradient reduces thermal stress on airfoil 221. Thirdly, the disclosed configuration reduces the number of expected peak stress locations in airfoil 221, since central spar 630 largely terminates into ribs 470, 480, and/or 490 along the serpentine cooling channels 410 and 420.

In addition, merge channel 440 may merge into an aft cooling channel 430 that extends along trailing edge 320 of airfoil 221, and ejects coolant along trailing edge 320 of airfoil 221 via outlets 439. Aft cooling channel 430 may be separated from outer cooling channel 410 by rib 480 and also comprise an aft inlet 431 that acts as a bypass, to supply trailing edge 320 with coolant at a lower temperature for improved cooling of trailing edge 320.

In an embodiment, one or more cooling holes 418 may be provided in an aft and radially outer portion of outer cooling channel 410 and/or one or more cooling holes 438 may be provided in a forward and radially outer portion of aft cooling channel 430. These cooling holes 418/438 may be angled at a position radially outward from rib 480 and extend through a surface on or near tip 330, to thereby provide local cooling to a region of tip 330 that is radially outward from rib 480. This region would otherwise not receive a flow of coolant.

In an embodiment, one or more outer cooling channel 410, inner cooling channel(s) 420, and aft cooling channel 430 comprise one or more trip strips 450 and/or pins 460 to promote heat exchange. In particular, trip strips 450 turbulate the flow of coolant through a cooling channel to promote turbulence, which enhances heat exchange, and pins 460 increase the surface area for heat exchange.

In an embodiment that comprises two inner cooling channels 420, pressure-side inner cooling channel 420P may have a different inner inlet 421P than the inner inlet 421S of suction-side inner cooling channel 420S. Thus, the flow of coolant through pressure-side inner cooling channels 420P may be controlled independently of the flow of coolant through suction-side inner cooling channels 420S. Accordingly, pressure side 610 and suction side 620 may be cooled independently of each other.

In an embodiment, inner cooling channels 420 may comprise or consist of pressure-side inner cooling channel 420P and suction-side inner cooling channel 420S, which may provide flow paths 520 that are in opposing directions. This counter-flow cooling scheme reduces the temperature gradient, in radial, axial, and lateral directions, within the region of inner cooling channels 420, and enables a reduction in the temperature of airfoil 221.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of turbomachine. Hence, although the present embodiments are, for convenience of explanation, depicted and described as being implemented in a gas turbine engine, it will be appreciated that it can be implemented in various other types of turbomachines and machines with blades that require cooling, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A turbine blade comprising:
a platform;
an airfoil extending radially outward from the platform;
a root extending radially inward from the platform;
an outer cooling channel within an interior of the turbine blade, wherein the outer cooling channel includes an outer first portion, an outer second portion, and an outer third portion, wherein the outer first portion extends radially along a leading edge of the airfoil from the platform towards a tip of the airfoil, wherein the outer second portion extends axially between a radially outer end of the outer first portion and a radially outer end of the outer third portion, and wherein the outer third portion extends radially inward from an aft end of the outer second portion;
one or more inner cooling channels within the interior of the turbine blade, wherein each of the one or more inner cooling channels includes an inner first portion, an inner second portion, and an inner third portion, wherein the inner first portion is aft of the outer first portion and extends radially from the platform to a position that is radially inward from the outer second portion, wherein the inner second portion extends axially between a radially outer end of the inner first portion and a radially outer end of the inner third portion, and wherein the inner third portion is forward of the outer third portion and extends radially inward from an aft end of the inner second portion; and
one or more cooling holes extending from the aft end of the outer second portion of the outer cooling channel towards the tip of the turbine blade.

2. The turbine blade of claim 1, wherein the one or more inner cooling channels are two inner cooling channels, wherein one of the two inner cooling channels is positioned on a pressure side of the turbine blade, and another one of the two inner cooling channels is positioned on a suction side of the turbine blade.

3. The turbine blade of claim 2, wherein at least a portion of a first inner cooling channel of the two inner cooling channels is separated from at least a portion of a second inner cooling channel of the two inner cooling channels by a central spar between a pressure-side wall and a suction-side wall of the airfoil.

4. The turbine blade of claim 3, wherein the central spar separates the inner first portion, the inner second portion, and the inner third portion of the first inner cooling channel from the inner first portion, the inner second portion, and the inner third portion, respectively, of the second inner cooling channel.

5. The turbine blade of claim 3, wherein the central spar separates an aft part of the inner second portion and an entirety of the inner third portion of the first inner cooling channel from an aft part of the inner second portion and an entirety of the inner third portion, respectively, of the second inner cooling channel.

6. The turbine blade of claim 5, wherein the central spar further separates an aft part of the outer second portion and an entirety of the outer third portion of the outer cooling channel into a pressure-side channel and a suction-side channel.

7. The turbine blade of claim 3, wherein a radially inner end of the inner first portion of each of the two inner cooling channels is in fluid communication with an inlet that supplies coolant to the inner first portion of the each of the two inner cooling channels, such that, when the coolant is supplied to the inlet, the coolant flows in a same direction from the inlet to the inner first portion of each of the two inner cooling channels, to the inner second portion of each of the two inner cooling channels, and to the inner third portion of each of the two inner cooling channels.

8. The turbine blade of claim 1, further comprising an aft cooling channel that is aft of the one or more inner cooling channels, wherein the aft cooling channel comprises an aft inlet that supplies coolant to the aft cooling channel, wherein a radially inner end of the inner first portion of at least one inner cooling channel of the one or more inner cooling channels is in fluid communication with an inner inlet that supplies coolant to the inner first portion of the at least one inner cooling channel, and wherein the aft inlet is separate from the inner inlet.

9. A turbine blade comprising:
a platform;
an airfoil extending radially outward from the platform;
a root extending radially inward from the platform;
an outer cooling channel within an interior of the turbine blade, wherein the outer cooling channel includes an outer first portion, an outer second portion, and an outer third portion, wherein the outer first portion extends radially along a leading edge of the airfoil from the platform towards a tip of the airfoil, wherein the outer second portion extends axially between a radially outer end of the outer first portion and a radially outer end of the outer third portion, and wherein the outer third portion extends radially inward from an aft end of the outer second portion;
one or more inner cooling channels within the interior of the turbine blade, wherein each of the one or more inner cooling channels includes an inner first portion, an inner second portion, and an inner third portion, wherein the inner first portion is aft of the outer first portion and extends radially from the platform to a position that is radially inward from the outer second portion, wherein the inner second portion extends axially between a radially outer end of the inner first portion and a radially outer end of the inner third portion, and wherein the inner third portion is forward of the outer third portion and extends radially inward from an aft end of the inner second portion; and
a merge channel, wherein the outer third portion of the outer cooling channel and the inner third portion of each of the one or more inner cooling channels is in fluid communication with the merge channel.

10. The turbine blade of claim 9, further comprising a turning vane extending laterally, between a pressure side and a suction side of the airfoil, through the merge channel.

11. The turbine blade of claim 9, further comprising an aft cooling channel that is aft of the one or more inner cooling channels, wherein the aft cooling channel includes an aft first portion that extends radially towards the tip of the airfoil, an aft second portion that extends axially from the aft first portion towards a trailing edge of the airfoil, and an aft third portion that extends axially from a radially outer end of the aft first portion towards the trailing edge of the airfoil, wherein the aft third portion is positioned radially outward from the aft second portion and is separated from the aft second portion by a rib, and wherein each of the aft second portion and the aft third portion comprises one or more outlets at the trailing edge of the airfoil.

12. The turbine blade of claim 11, wherein the aft first portion is in fluid communication with the aft second portion via a plurality of discrete cross-overs, and wherein the radially outer end of the aft first portion transitions into the aft third portion without any discrete cross-overs.

13. The turbine blade of claim 11,
wherein the outer cooling channel is separated from the one or more inner cooling channels by a first rib that includes a first rib portion that separates the outer first portion of the outer cooling channel from the inner first portion of each of the one or more inner cooling channels, a second rib portion that separates the outer second portion of the outer cooling channel from the inner second portion of each of the one or more inner cooling channels, and a third rib portion that separates the outer third portion of the outer cooling channel from the inner third portion of each of the one or more inner cooling channels,
wherein each of the one or more inner cooling channels is separated from the aft cooling channel by a second rib, and
wherein a radially innermost end of the third rib portion of the first rib is farther from the platform than a radially innermost end of the second rib.

14. The turbine blade of claim 11, further comprising:
a first set of one or more cooling holes extending from the aft end of the outer second portion of the outer cooling channel towards the tip of the turbine blade; and
a second set of one or more cooling holes extending from the radially outer end of the aft first portion of the aft cooling channel towards the tip of the turbine blade.

15. The turbine blade of claim 9, further comprising a turning vane extending laterally, between a pressure side and a suction side of the airfoil, through one or both of a transitional region between the outer first portion and the outer second portion of the outer cooling channel or a transitional region between the outer second portion and the outer third portion of the outer cooling channel.

16. The turbine blade of claim 9, further comprising a turning vane extending laterally, between a pressure side and a suction side of the airfoil, through the inner second portion of each of the one or more inner cooling channels.

17. The turbine blade of claim 9, wherein the outer cooling channel comprises a plurality of trip strips.

18. The turbine blade of claim 9, wherein each of the one or more inner cooling channels comprises a plurality of pins extending laterally between a pressure side and a suction side of the airfoil.

19. A turbine blade comprising:
a platform;
an airfoil extending radially outward from the platform;
a root extending radially inward from the platform;
a first inner cooling channel within an interior of the turbine blade on a first lateral side of the turbine blade; and
a second inner cooling channel within the interior of the turbine blade on a second lateral side of the turbine blade that is opposite the first lateral side,
wherein each of the first and second inner cooling channels includes a first portion, a second portion, and a third portion, wherein the first portion extends radially from the platform towards a tip of the airfoil, wherein the second portion extends axially between a radially outer end of the first portion and a radially outer end of the third portion, and wherein the third portion extends radially inward from an aft end of the second portion,
wherein the first portion of the first inner cooling channel is in fluid communication with a first inlet that supplies coolant to the first portion of the first inner cooling channel, such that, when the coolant is supplied to the first inlet, the coolant flows in a first direction from the first inlet to the first portion of the first inner cooling channel, to the second portion of the first inner cooling channel, and to the third portion of the first inner cooling channel, and
wherein the third portion of the second inner cooling channel is in fluid communication with a second inlet that supplies coolant to the third portion of the second inner cooling channel, such that, when the coolant is supplied to the second inlet, the coolant flows in a second direction, which is reverse of the first direction, from the second inlet to the third portion of the second inner cooling channel, to the second portion of the second inner cooling channel, and to the first portion of the second inner cooling channel.

20. The turbine blade of claim 19, further comprising a merge channel, wherein the third portion of the first inner cooling channel is connected to the merge channel, and wherein the first portion of the second inner cooling channel is connected to the merge channel.
